(19) United States
(12) Patent Application Publication
(10) Pub. No.: US 2008/0164253 A1
(43) Pub. Date: Jul. 10, 2008

(54) DUAL FOOD CONTAINER SYSTEM AND METHOD FOR QUICK SERVING OF COMPLEMENTARY FOOD ITEMS

(76) Inventor: Quang-Vinh Truong, Fullerton, CA (US)

Correspondence Address: QUICKPATENTS, INC., 32861 CALLE PERFECTO, SUITE A, SAN JUAN CAPISTRANO, CA, 92675, US

(21) Appl. No.: 11/620,533

(22) Filed: Jan. 5, 2007

(51) Int. Cl. B65D 8/04; A23L 1/00; B65B 1/00; B65D 1/40

(52) U.S. Cl. 220/4.27; 426/120; 426/87; 220/729

(57) ABSTRACT

A container system and a method of its use is disclosed. The container system comprises a first container attachable to a second container. Each of the first and second containers include a housing open at one end thereof and defining an internal volume therein. An attachable closure seals each open end. The first container includes either a reception means or an attachment means in a second end thereof. The reception means is for receiving a separate attachment means, which may be a separate piece or integrally formed with the attachable closure of the second container. A variety of embodiments may be made as needed with various forms of an attachment means. For example, the second container may or may not include a second closure means, and may or may not include a threaded male portion based on the attachment means including or not including a cooperating threaded female portion. The reception means may or may not include adhesive for permanently engaging the attachment means, a high-friction surface for a temporary, friction fit with the attachment means, or a threaded female portion that cooperates with a threaded male portion of the attachment means. Each of the first and second containers may further include on the housings thereof an indicia for indicating that the second container is attachable to the first container. As such, a user is alerted that two separated containers may be combinable by seeing a similar indicia on each.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to food and beverage containers, and more particularly to a system of containers for mixing different combinations of containers that are mutually attachable.

### DISCUSSION OF RELATED ART

Double containers are known in the art, and are useful when carrying two items that do not mix well or that should not be mixed until just before use. For example, milk and cereal cannot be stored in the same container for extended periods of time since milk will eventually make the cereal soggy and unappealing. Instant soup and hot water is another example of such food items.

Examples of double containers that have been devised heretofore, particular for use with cereal and milk, include U.S. Pat. No. 6,913,777 to Rebhorn et al. on Jul. 5, 2005; U.S. 2002/0114870 to Rebhorn et al. on Aug. 22, 2002; U.S. Pat. No. 5,318,787 to Brauner et al. on Jun. 7, 1994; U.S. Pat. No. 5,727,679 to Newarski on Mar. 17, 1998; U.S. Pat. No. 5,753,289 to Ness on May 19, 1998; and U.S. Pat. No. 5,987,913 to Andrzejczak on Nov. 23, 1999. Such containers typically use two compartments, one for containing milk and the other for containing cereal, for instance. With the one exception of the—913 patent, the containers of such devices are not separable. As such, each compartment must be filled substantially simultaneously with the desired cereal and milk types before being sealed. With the large number of available cereals to chose from, and the growing number of milk products, such as 1%, 2%, whole, non-fat, soy, etc., the resulting number of combinations are impractical to store, transport, and manufacture. Retailers often have limited shelf space, and as such, the use of such containers is not suitable for retailers desiring to offer a wide selection of combinations.

The—913 patent teaches a set of stackable containers, each fixed to the next. However, this device includes a cereal bowl as one of the components, and as such is relatively bulky in use and expensive for single-use offerings, as would be common in a retail establishment. Further, such a device is not practical to use in offering a variety of cereals with a variety of different types of milk in a retail environment, since each compartment is not individually sealable without necessarily connecting with the next compartment.

U.S. Pat. No. 4,444,324 to Grenell on Apr. 24, 1984, teaches a stackable multi-part container for transporting at least two different food substances. Such a device requires a medial connector between each container, however, and thus each container cannot be stored or displayed separately and still remain sealed, as would be required in a retail environment. US Design Pat. 324,173 to Lynd on Feb. 25, 1992 succumbs to the same drawbacks.

U.S. Patent Application 2005/0098526 to Catalin on May 12, 2005 teaches a bottle having a threaded receiving portion in a bottom thereof for receiving the threaded neck of a second bottle or container. Again, no mention of a separately sealable second container is made, making such a device impractical for use in a retail environment wherein each container is displayed separately. Similar drawbacks exist for references cited against this application by the Examiner, namely, U.S. Pat. No. 475,231 to Anderson on May 17, 1892; U.S. Pat. No. 3,067,896 to Berg et al. on Dec. 11, 1962; and U.S. Pat. No. 815,883 to Van Blarcom on Mar. 20, 1906.

U.S. Pat. No. 2,488,611 to Stallings on Nov. 22, 1949 teaches stackable containers each having a threaded plug for separately sealing each container. While such a device would be suitable for use in a retail environment, such as where a milk container is displayed in a refrigerated section and a cereal container is displayed in a separate aisle, for example, the plug on such a device is not easily removed manually. While other types of closures may be considered obvious to use with such a device, none are suggested and the prior art is limited in this regard. The containers in such a device are insulated and are clearly not intended for single-use based on their relatively expensive construction. Further, such separate containers cannot be nested together for compact storage. Still further, there is no indicia suggested for alerting users that such containers, when separate, are combinable. Similar drawbacks exist for those devices taught in U.S. Pat. No. 2,836,323 to Robinson on Jun. 22, 1956; U.S. Pat. No. 647,925 to Kirby on Apr. 17, 1900; and U.S. Pat. No. 2,326,414 to Thompson on Aug. 10, 1943.

Typically, cereal is eaten with milk, but milk is not introduced into the cereal until just prior to consuming it. This is also the practice at several cereal-type restaurant facilities such as Cereality (www.cereality.com), The Cereal Bowl (www.thecerealbowl.com), Cereal Barn (www.cerealbarn.com), and Java Flakes (www.javaflakes.com). In such restaurants, consumers receive the cereal of their choice in a disposable bowl or container, and then dispense their choice of milk into the cereal before eating. Typically a line is formed at the milk dispensers, which clearly is time consuming and inconvenient for the consumer. Further, milk dispensers may become contaminated if a consumer sneezes or otherwise fouls such a public dispenser. For those who wish to take their cereal and milk “to go,” two separate containers are provided, which is inconvenient for the consumer.

Therefore, there is a need for an inexpensive container system that is suited for single-use wherein two separate containers are attachable to form one convenient transportable unit. Each container in the needed invention would be separately storable in a sealed, sanitary state, so as to be displayed in separate areas of a retail environment, and quickly selected by the consumer without waiting for dispensing of food products into either container. The needed system would allow restaurant locations to provide an easy way to let consumers take two food products “to go” with a single, attached and convenient package. The needed system would provide means for users to readily ascertain that the two containers are mutually attachable. Further, the needed system would include a variety of embodiments suitable for differing applications, including a multi-use application wherein the second container fits within the first container for compact storage thereof. Such a needed system would provide means for safety sealing each container against tampering, and would provide means for keeping one or both containers at a desired temperature for a length of time. The present invention accomplishes these objectives.

### SUMMARY OF THE INVENTION

The present device is a container system comprising a first container and a second container. In all embodiments of the invention, the first container is selectively attachable to the second container. The first container includes a housing open at one end thereof and defining an internal volume therein. An attachable closure seals the one end. Likewise, the second container has a housing open at one end and defining an internal volume therein. An attachable closure for sealing the one end may be included. The first container includes either a reception means or an attachment means in a second end thereof. The reception means is for receiving a separate attachment means, which may be integrally formed with the attachable closure of the second container.

A variety of embodiments may be made as needed with various forms of an attachment means. For example, the second container may or may not include a second closure means, and may or may not include a threaded male portion based on the attachment means including or not including a cooperating threaded female portion. The reception means may or may not include adhesive for permanently engaging the attachment means, a high-friction surface for a temporary, friction fit with the attachment means, or a threaded female portion that cooperates with a threaded male portion of the attachment means.

Further, the second container may further include an outer container fixed thereto proximate the attachable closure thereof. The second container and the outer container define a second internal volume therebetween for containing, for example, a thermally active or insulating substance that may be frozen so as to impart a cooling effect on any contents in the internal volume of the second container.

Each of the first and second containers may further include on the housings thereof an indicia for indicating that the second container is attachable to the first container. As such, a user is alerted that two separated containers may be combinable by seeing a similar indicia on each.

In use, a customizable combination of food items may be offered. First, a plurality of sealed first containers are offered, each of which has one of a plurality of food substances, such as a type or brand of cereal. Second, a plurality of sealed second containers are offered, each of which has one of a plurality of alternate food substances, such as a type or brand of milk. As such, a customer may pick and choose one from among the plurality of first containers and one from the second containers, and then attach the two containers together for convenient transportation and storage thereof.

In a non-disposable embodiment, the containers are each made from a dishwasher-safe material, such as plastic. The attachable closures are also each made from a similar plastic or dishwasher-safe material, and for convenience the second container is able to completely traverse the open end of the first container to fit within the internal volume of the first container for compact storage of the container system.

The present invention is an inexpensive container system that is suited for single-use wherein two separate containers are attachable to form one convenient transportable unit. Each container in the present invention is separately storable in a sealed state, so as to be displayed in separate areas of a retail environment. The present system provides means for users to readily ascertain that the two containers are combinable. Further, the inventive system includes a variety of embodiments suitable for differing applications, including a multi-use application wherein the second container fits within the first container for compact storage thereof. The present system provides means for safety sealing each container against tampering, and for keeping one or both containers at a desired temperature for a length of time.

The invention further allows cereal restaurants to offer a convenient take-out or delivery service, and allows consumers to enjoy cereal anywhere, such as in a car, at a workplace, etc., in fast and convenient way. The invention is also useful for offering an all-in-one package for food and drink, particularly for out-of-home and on-the-go consuming. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1A is an exploded perspective view of one embodiment of the invention;

FIG. 1B is an exploded perspective view of an alternate embodiment of the invention;

FIG. 1C is an exploded perspective view of another alternate embodiment of the invention;

FIG. 1D is an exploded perspective view of yet another alternate embodiment of the invention;

FIG. 1E is an exploded perspective view of yet another alternate embodiment of the invention;

FIG. 2 is a partial cross-sectional view of one embodiment of the invention, taken generally along lines 3-3 of FIG. 9;

FIG. 3 is a partial cross-sectional view of an alternate embodiment of the invention, taken generally along lines 3-3 of FIG. 9;

FIG. 4 is a partial cross-sectional view of another alternate embodiment of the invention, taken generally along lines 3-3 of FIG. 9;

FIG. 5 is a partial cross-sectional view of yet another alternate embodiment of the invention, taken generally along lines 3-3 of FIG. 9;

FIG. 6A is a partial cross-sectional view of yet another alternate embodiment of the invention, taken generally along lines 3-3 of FIG. 9;

FIG. 6B is a partial cross-sectional view of the embodiment of the invention illustrated, in FIG. 6A, and taken generally along lines 6B-6B of FIG. 6A;

FIG. 7 is a perspective view of a multi-use embodiment of the invention, illustrating a second container nestable in a first container;

FIG. 8 is a perspective view of the invention, illustrating one embodiment of the invention and wherein the first container is engaged with the second container;

FIG. 9 is a perspective view of the invention, illustrating an alternate embodiment of the invention and wherein the first container is engaged with the second container; and

FIG. 10 is a perspective exploded view of the second container of the invention, illustrating an outer container with a thermally active substance therein.

### DETAILED DESCRIPTION OF THE PREFERRED EMBODIMENT

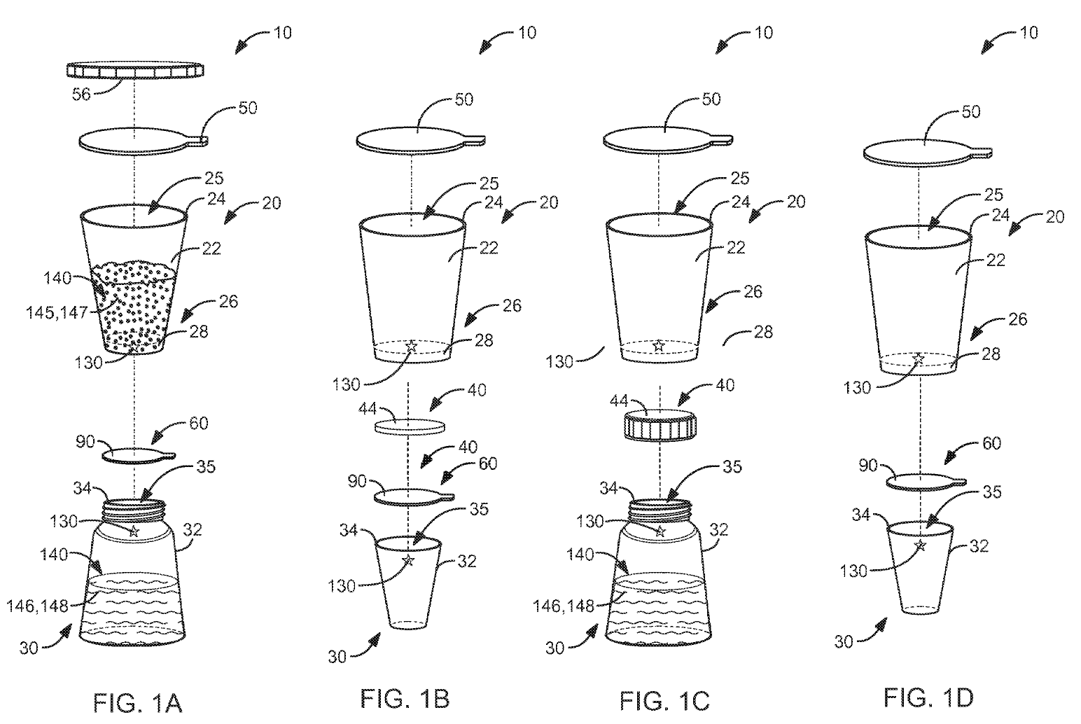

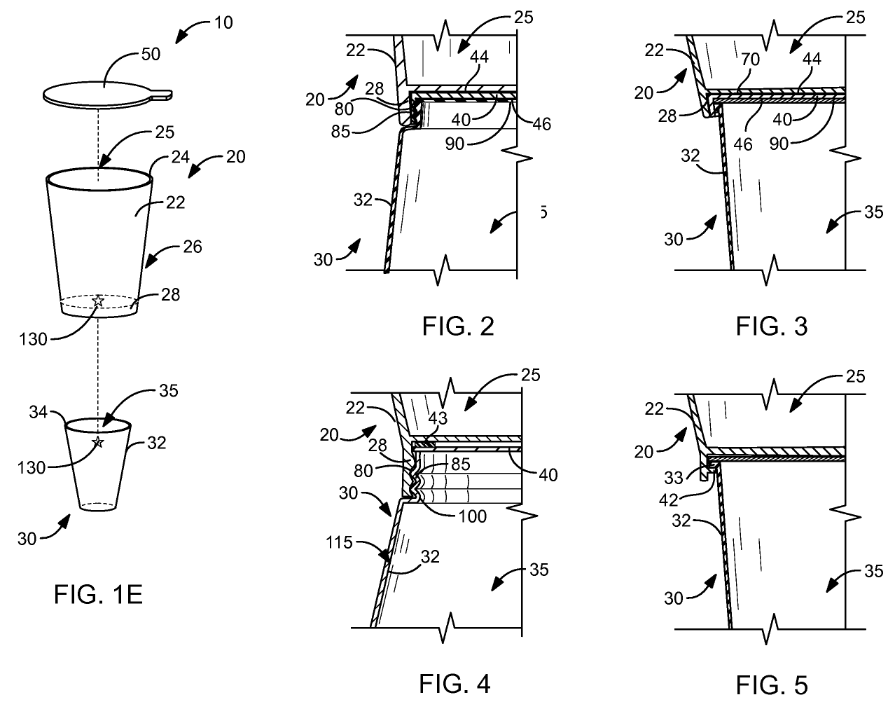

FIGS. 1A through 1B illustrate a container system 10 comprising a first container 20 and a second container 30. In all embodiments of the invention, the first container 20 is selectively attachable to the second container 30. The first container 20 includes a housing 22 open at one end 24 thereof and defining an internal volume 25 therein. An attachable closure 50 seals the one end 24, and an optional snap-on or threaded lid 56 may further be included (FIG. 1A). Likewise, the second container 30 has a housing 32 open at one end 34 and defining an internal volume 35 therein. An attachable closure 60 for sealing the one end 34 may be included, such as a flexible plastic or foil closure sonically or adhesively sealed.

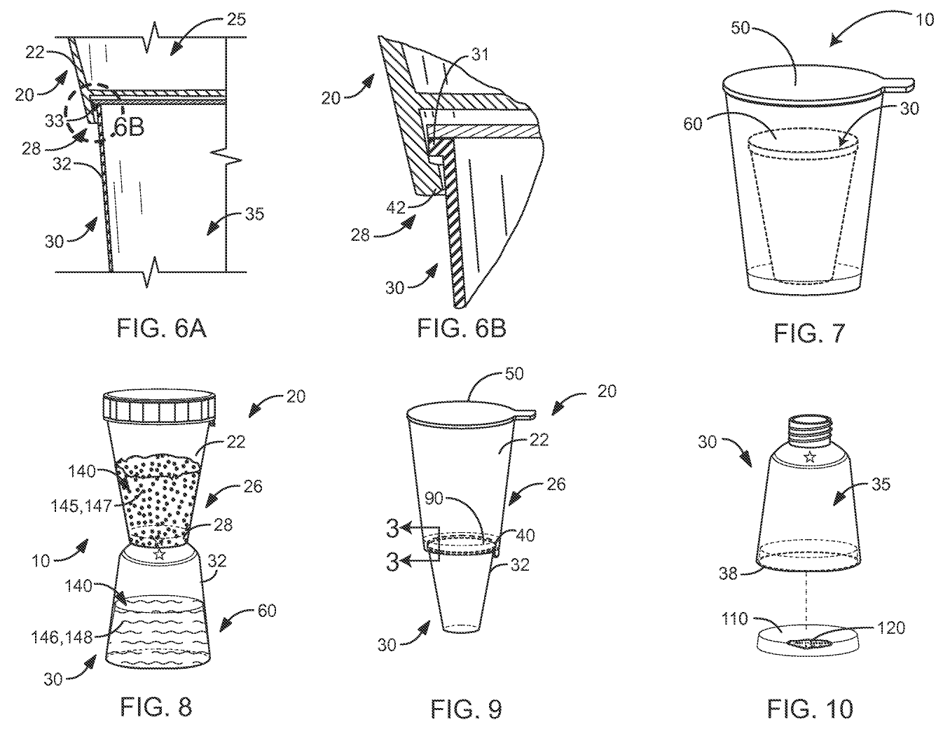

In the simplest embodiment of the invention, illustrated in FIGS. 1E and 6A, an attachment means 40 is formed in a second end 26 of the first container 20, and is adapted to receive and seal the one end 34 of the second container 30. In such an embodiment, the open one end 34 of the second container 30 is adapted to make a tight snap-fit with the attachment means 40. For example, the attachment means 40 in such an embodiment may be a lip 42 (FIGS. 2 and 6B) that cooperates with a cooperating lip 33 of the second container 30 (FIG. 5), or which takes the form of a frusto-conical second end 26, as shown in FIGS. 6A and 6B. Alternately, the attachment means 40 may be a threaded female portion 80 (FIG. 4), adapted for receiving a threaded male portion 85 of the second container 30. With this embodiment, a peripheral compressible seal 43 may be included to further help seal the open end 34 of the second container 30 when engaged with the attachment means 40 of the first container 20 (FIG. 4).

In a preferred embodiment of the invention, the first container 20 includes a reception means 28 formed in the second end 26 thereof (FIGS. 1E and 4). The reception means 28 receives the attachment means 40 at one side 44 thereof (FIGS. 2, 3 and 4). A second side 46 of the attachment means 40 is selectively engageable with the closure 60 of the second container 30. Thus, by way of example, the one side 44 of the attachment means 40 may include adhesive 70 to permanently fix the attachment means 40 to the reception means 28 (FIG. 3). Alternately, the one side 44 of the attachment means 40 may cooperate with the lip 42 of the reception means 28 of the first container 20 to be retained thereby.

In another embodiment of the invention, illustrated in FIGS. 1B and 3, the first side 44 of the attachment means 40 snaps into and is retained by the reception means 28 of the first container 20. The second container 30 engages the attachment means 40.

The second side 46 of the attachment means 40 may be the threaded female portion 80, and the container 30, for example, may include the threaded male portion 85 as its attachable closure 60, the threaded male portion 85 screwing into the threaded female portion 80 to seal the second container 30 and substantially attach the second container 30 to the attachment means 40 (FIGS. 1C and 4). The second container 30 may further include a second closure means 90 such as a removable seal across the open end 34 of the second container 30 (FIGS. 1A, 1B, 1D and 3).

As such, a variety of embodiments may be made as needed with the various attachment means 40. For example, the second container 30 may or may not include the second closure means 90, and may or may not include the threaded male portion 85 based on the attachment means 40 including or not including the cooperating threaded female portion 80. The reception means 28 may or may not include the adhesive 70. The embodiments illustrated in FIGS. 1A-1E illustrate some of the various combinations that can be obtained.

Further, as illustrated in FIG. 10, the second container 30 may further include an outer container 110 fixed thereto, such as by snapping into a recess 38 in a bottom portion of the second container 30. The outer container 110 contains a thermally active substance 120 that may be frozen so as to impart a cooling effect on any contents in the internal volume 35 of the second container 30. The thermally active substance 120 may alternately be an insulating substance or a heating substance.

Each of the first and second containers 20,30 may further include on the housings 22,32 thereof an indicia 130 for indicating that the second container 30 is attachable to the first container 20. As such, a user is alerted that two separated containers 20,30 may be combinable by seeing a similar indicia 130 on each (FIG. 1A).

In use, a customizable combination of food items 140 may be offered. First, a plurality of sealed first containers 20 are offered, each of which has one of a plurality of food substances 145, such as a type or brand of cereal 146 (FIG. 1A). Second, a plurality of sealed second containers 30 are offered, each of which has one of a plurality of alternate food substances 146, such as a type or brand of milk 148. As such, a customer may pick and choose one from among the plurality of first containers 20 and one from the second containers 30, and then attach the two containers 20,30 together for convenient transportation and storage thereof. In such use, the containers 20,30 are typically disposable, being made either of plastic, paperboard, or the like. Each container 20 may be made of a different material than the cooperating container 30. For example, the first container 20 may be made from a paperboard or plastic material, and the second container 30 may be made from a glass material. Clearly, any suitable material may be used for the first container 20, the second container 30, and the attachment means 40, as is known in the art.

In a non-disposable embodiment, the containers 20,30 are each made from a dishwasher-safe material, such as plastic. The attachable closures 56,40 are also each made from a similar plastic or dishwasher-safe material, and for convenience the second container 30 is able to completely traverse the open end 24 of the first container 20 to fit within the internal volume 25 of the first container 20 (FIG. 7).

While a particular form of the invention has been illustrated and described, it will be apparent that various modifications can be made without departing from the spirit and scope of the invention. For example, the exact materials used for each container 20,30 and the attachment means 40 may be varied as necessary based on the intended application. Accordingly, it is not intended that the invention be limited, except as by the appended claims.

What is claimed is:

1. A container system comprising:
a first container having a housing open at one end and defining an internal volume, an attachable closure for selectively closing the one end, and an attachment means formed in a second end thereof, and
a second container having a housing open at one end and defining an internal volume, and having an attachable closure for selectively closing the one end;
whereby the second container may be attached to the attachment means of the first container at the closure thereof.

2. A container system comprising:
a first container having a housing open at one end and defining an internal volume, an attachable closure for selectively closing the one end, and a reception means formed in a second end thereof;
a second container having a housing open at one end and defining an internal volume, and having an attachable closure for selectively closing the one end; and
an attachment means comprising one side engageable with the reception means of the first container and a second side selectively engageable with the closure of the second container;
whereby the second container may be attached to the reception means of the first container at the closure thereof by the attachment means.

3. The container system of claim 1 wherein the second container is able to completely traverse the open end of the first container and fit within the internal volume of the first container.

4. The container system of claim 2 wherein the attachment means is fixed within the reception means of the first container with adhesive.

5. The container system of claim 2 wherein the attachment means is fixed within the reception means of the first container with a snap fit.

6. The container system of claim 2 wherein the second side of the attachment means is a threaded female portion, and the attachable closure of the second container is a cooperating threaded male portion, whereby the second container screws into the attachment means, the attachment means engaged with the reception means of the first container.

7. The container system of claim 6 wherein the second container further includes a second closure means comprising a removable seal across the open end of the second container.

8. The container system of claim 1 wherein the first container and the second container each include on an outer surface thereof an indicia for indicating that the second container is attachable to the first container.

9. The container system of claim 1 wherein the second container further includes a recess in a bottom portion thereof, and wherein an outer container with a thermally active substance therein may be snap-fitted into the recess so as to impart a thermal effect to the internal volume of the second container.

10. A method of offering a customizable combination of food items, comprising the steps of:
a) offering one of a plurality of first containers each having a housing open at one end and defining an internal volume, an attachable closure for sealing the one end, and an attachment means formed in a second end thereof, each of the first containers containing one of a plurality of food substances; and
b) offering one of a plurality of second containers each having a housing open at one end and defining an internal volume, and each having an attachable closure for sealing the one end, each of the second containers containing one of a plurality of alternate food substances, each second container being attachable to the reception means of each first container at the closure thereof by the attachment means.

11. The method of offering a customizable combination of food items of claim 10 wherein each first container and each second container further include on an outer surface thereof an indicia for indicating that each second container is attachable to each first container.

12. The method of offering a customizable combination of food items of claim 10 wherein each first container contains a type of dry cereal, and wherein each second container contains a type of milk.
